(19) United States
(12) Patent Application Publication
(10) Pub. No.: US 2013/0259404 A1
(43) Pub. Date: Oct. 3, 2013

(54) METHOD OF PROCESSING AN IMAGE

(71) Applicant: I-ALIGN LIMITED, Wakefield (GB)

(72) Inventors: Alan Lewis Benstock, Wakefield (GB); Marcus Dyson, Wakefield (GB); Gavin Dodds, Wakefield (GB)

(21) Appl. No.: 13/851,432

(22) Filed: Mar. 27, 2013

(30) Foreign Application Priority Data
Mar. 27, 2012 (GB) GB1205340.1

(51) Int. Cl. G06T 3/20

(52) U.S. Cl. CPC G06T 3/20
USPC 382/295

(57) ABSTRACT

A method of processing an image comprising the steps of
(a) providing an image;
(b) identifying at least two points within the image; and,
(c) positioning the image within an image frame such that the distance between the two points in the frame is a predetermined length, the predetermined length being a predetermined percentage of a dimension of the image frame.

The present invention relates to a method of processing an image. More particularly, but not exclusively, the present invention relates to a method of processing an image comprising the steps of identifying two or more points within the image and then arranging the image within an image frame so that the distance between the points occupies a predetermined percentage of the total length or area within the image frame.

Current methods of positioning an image within an image frame do so by offering the user an image frame in which to manipulate and position the image. Such methods do not ensure that selected features of the image occupy the same space within the image frame. This leads to inconsistency in image collection and display.

The method according to the invention seeks to overcome the problems of the prior art.

Accordingly, in a first aspect, the present invention provides a method of processing an image comprising the steps of
(a) providing an image;
(b) identifying at least two points within the image; and,
(c) positioning the image within an image frame such that the distance between the two points in the frame is a predetermined length, the predetermined length being a predetermined percentage of a dimension of the image frame.

Images processed by the method always occupy the same space within the image frame, irrespective of the size of the initial provided image. In addition, there are very few subjective decisions to be made during performance of the method. It is merely necessary to identify the points of interest in the original image. The method then ensures that the final image in the image frame is of the correct dimensions.

Preferably, the image frame has a width and a height and the predetermined length is a percentage of at least one of these.

The image frame can be rectangular.

Preferably, the image is arranged in the image frame such that at least one point along the line between the two identified points is a predetermined distance from at least one edge of the image frame.

Preferably, the image is arranged within the image frame such that the line between the points is arranged in a predetermined orientation with respect to the image frame.

The line can be arranged to be parallel to at least one edge of the image frame.

The image can be a digital image and the image frame can be a software generated frame.

In a further aspect of the invention there is provided a method of processing an image comprising the steps of
(a) providing an image;
(b) identifying a plurality of points within the image to define an image area; and,
(c) arranging the image within an image frame such that the image area is a predetermined percentage of the area of the image frame.

The method according to the invention has the advantage that images processed by the method always occupy the same proportion of the space within the image frame, irrespective of the size of the initial provided image

The image area can be arranged in a predetermined orientation within the image frame.

Preferably, at least one edge of the image area is arranged to be parallel to an edge of the image frame.

Preferably, at least one point of the image area is arranged to be a predetermined distance from at least one edge of the image frame.

The image can be a digital image and the image frame can be a software generated frame.

The present invention will now be described by way of example only and not in any limitative sense with reference to the accompanying drawings in which

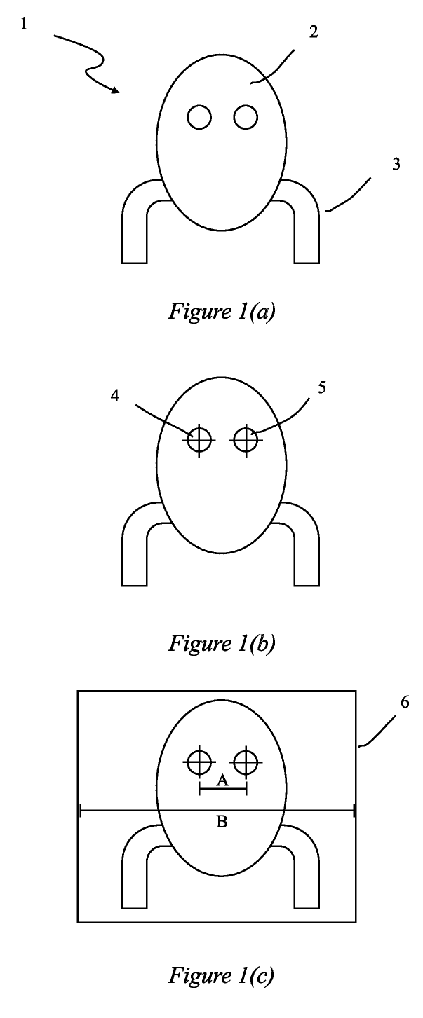

FIGS. 1(a) to 1(c) show, in schematic form, a first embodiment of a method according to the invention;

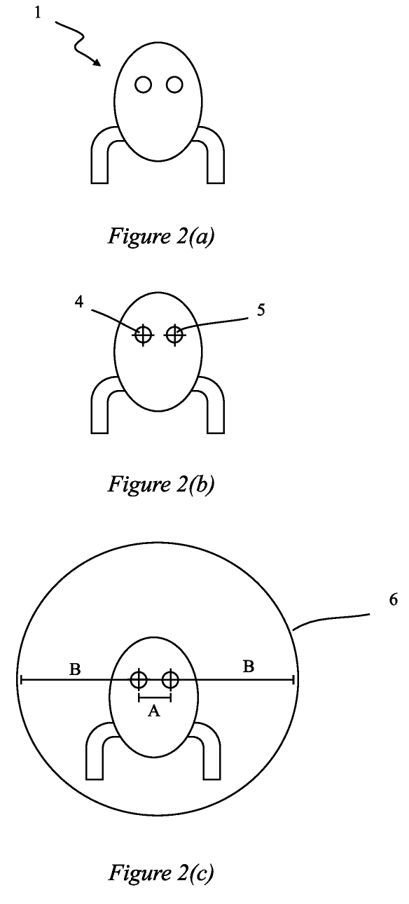

FIGS. 2(a) to 2(c) show, in schematic form, a second embodiment of a method according to the invention; and,

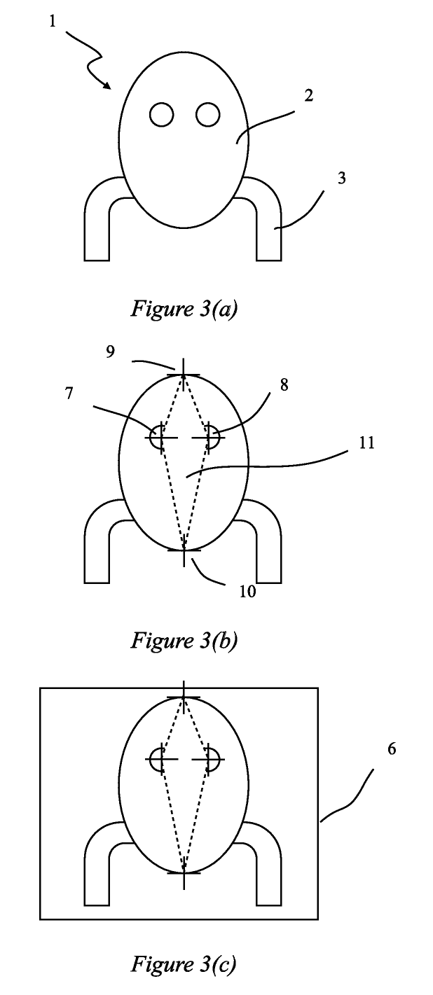

FIGS. 3(a) to 3(c) show, in schematic form, a third embodiment of a method according to the invention.

Shown in FIGS. 1(a) to 1(c) is a first embodiment of a method according to the invention. In a first step an image 1 is provided. In this embodiment the image 1 is of the head 2 and shoulders 3 of a person.

In a second step two points of interest 4,5 in the image 1 are marked. In this case the two points of interest 4,5 are the eyes of the person.

Once the two points of interest 4,5 have been marked the image 1 is positioned within an image frame 6 such that the distance A between the two points 4,5 in the image frame 6 is a predetermined length. In this embodiment the image frame 6 is rectangular and the image 1 is arranged such that the distance between the points 4,5 is a predetermined percentage of the width B of the image frame 6. As a typical example with a human head shot this predetermined percentage is around 30 to 50%, more particularly around 35 to 45% the width of the image frame 6.

This in itself does not uniquely determine the position of the image 1 in the image frame 6. In this embodiment the image 1 is also rotated so that the line between the two identified points 4,5 is arranged in a predetermined orientation with respect to the image frame 6. In particular, in this embodiment the line is arranged to be parallel to the bottom edge of the image frame 6. Further, the end point 4 of the line (one of the identified points) is arranged to be a predetermined distance from the bottom and one of the sides of the image frame 6.

Shown in FIGS. 2(a) to 2(c) is a further embodiment of a method according to the invention. Steps 2(a) and 2(b) are as before. In this embodiment the image frame 6 is circular as shown in FIG. 2(c). In this embodiment the image 1 is arranged in the image frame 6 with the distance between the two identified points 4,5 being a predetermined percentage of the circumference of the image frame 6. The image 1 is arranged such that the line between the points 4,5 lies horizontally within the image frame 6. The line is further arranged such that the center of the line lies at the center point of the image frame 6.

FIGS. 3(a) to 3(c) show, in schematic form, a further embodiment of a method according to the invention. In this embodiment an image 1 is provided as before. A plurality of points 7-10 in the image 1 is identified to define an image area 11. In this embodiment the image 1 is the head 2 and shoulders 3 of a person and the identified points 7-10 are the two eyes 7,8 of the person, the top of the head 9 and the chin 10.

The image 1 is then arranged within an image frame 6 such that the image area 11 is a predetermined area of the image frame 6. This ensures that the image 1 within the image frame 6 is always of the same size irrespective of the size of the initial image 1.

The image area 11 is also oriented with respect to the image frame 6 as shown with two points 9,10 defining the top and bottom of the image area 11 in the same vertical line. The image 1 is further arranged with the top point of the image area 11 a predetermined distance from the top edge and side edges of the image frame 6.

The methods of image processing according to the invention find particular application in the field of computing. A user of an application (for example a social networking application such as Facebook) will upload a digital image to an application server. The application server provides a page, typically over the internet to a web browser, displaying the image in an image frame. More generally, the image is a digital image and the image frame is a software generated frame which holds the image. The application server may perform the method according to the invention before displaying the image in the image frame. Alternatively/additionally the application may perform the method on request from the user.

What is claimed:

1. A method of processing an image comprising the steps of
(a) providing an image;
(b) identifying at least two points within the image; and,
(c) positioning the image within an image frame such that the distance between the two points in the image frame is a predetermined length, the predetermined length being a predetermined percentage of a dimension of the image frame.

2. A method as claimed in claim 1, wherein the image frame has a width and a height and the predetermined length is a percentage of at least one of these.

3. A method as claimed in claim 2, wherein the image frame is rectangular.

4. A method as claimed in claim 1, wherein the image is arranged in the image frame such that at least one point along the line between the two identified points is a predetermined distance from at least one edge of the image frame.

5. A method as claimed in claim 1, wherein the image is arranged within the image frame such that the line between the points is arranged in a predetermined orientation with respect to the image frame.

6. A method as claimed in claim 5 where the line is arranged to be parallel to at least one edge of the image frame.

7. A method as claimed in claim 1, wherein the image is a digital image and the image frame is a software generated frame.

8. A method of processing an image comprising the steps of
(a) providing an image;
(b) identifying a plurality of points within the image to define an image area; and,
(c) arranging the image within an image frame such that the image area is a predetermined percentage of the area of the image frame.

9. A method as claimed in claim 8, wherein the image area is arranged in a predetermined orientation within the image frame.

10. A method as claimed in claim 9, wherein at least one edge of the image area is arranged to be parallel to an edge of the image frame.

11. A method as claimed in claim 8, wherein at least one point of the image area is arranged to be a predetermined distance from at least one edge of the image frame.

12. A method as claimed in claim 8, wherein the image is a digital image and the image frame is a software generated frame.
